(19) United States
(12) Patent Application Publication
(10) Pub. No.: US 2020/0178491 A1
(43) Pub. Date: Jun. 11, 2020

(54) Universal Litter Box

(71) Applicant: Karen Christine Boynton, Las Vegas, NV (US)

(72) Inventor: Karen Christine Boynton, Las Vegas, NV (US)

(21) Appl. No.: 16/660,717

(22) Filed: Oct. 22, 2019

Related U.S. Application Data
(60) Provisional application No. 62/766,560, filed on Oct. 26, 2018.

(51) Int. Cl. A01K 1/01

(52) U.S. Cl. CPC A01K 1/0107

(57) ABSTRACT

The “Universal Litter Box” was designed with high walls to benefit both male and female pets. Since most litter boxes are used for female pets, litter is used to cover a pet's relief, whether it be urine or feces. It may not be all the time, but as usual, it is when you have company. No matter where you put the box, the company will end up walking on the litter! Hopefully, it is not with their bare feet! Having high walls can prevent the litter from flying out of the box when dispersing from the pet's paws. Also, male dogs like to lift their legs when urinating. This makes high walls an option for them to use for training. But, when using the “Tree” or “Fire Hydrant” in the litter box, the high sides will help prevent the urine from ending up on the walls and floor.

### FIELD OF INVENTION

The invention relates to the use of litter boxes mainly by Male pets but not to exclude Female pets. Obviously, there are many litter boxes available but this invention includes an addition for Male pets.

### BACKGROUND

The litter box has been generally used by the public for female pets for quite some time and there are many different sizes to choose from. The traditional litter box is rectangular with three raised sides and one side raised but has a dip in it for the pet to enter. Of course, the reason it is called a “litter box” is because it uses “litter” as its main ingredient. This has worked well for mostly attracting female cats. But female cats like to kick up litter to cover their duty. That ends up all over the floor.

That is one of the reasons why a litter box with higher walls is very important. Higher walls will eliminate worrying about where the litter will end up.

The litter box has worked well for female pets but, it seems now, more and more pet owners have moved on to male pets in their homes. It also seems a lot of people are moving into smaller homes, apartments and condos. This leaves the pet in the premises without relief all day. Male pets have mostly been forced to hold their urine or feces in all day until their owner comes home from work in order to go for a walk. Or, they are caged all day, and may have to lay in their own urine or feces until their owner comes home to take them for a walk and then give them a bath! This now creates a particular need for products that allow pet owners to indoor potty train their pets.

Female pets are fairly easy to indoor potty train due to the stance they use to urinate or defecate. But once a male pet reaches a certain age, they like to lift their leg. If there isn't anything to lift their leg on, they tend to avoid the use of the litter box and go look for something more appropriate, like a couch or table leg or curtain! Something you would definitely prefer them not to use.

Hence, there is a need for an affordable “Universal Litter Box” useable to provide them with a means to relieve themselves indoors. This invention will help solve the aforementioned problems associated with current housetraining and indoor potty devices.

### SUMMARY OF INVENTION

Besides the high walls, each box includes a “Tree” and “Fire Hydrant” on a suction cup making it easy to attach on the bottom of the box to best suit your pets aim (both are washable and reusable). These are made so the urine can flow right off them and down to the litter.

There can be different sizes based on the size of your pet.

### BRIEF DESCRIPTION OF THE DRAWINGS

These and other features will be apparent from the description following the drawings:

FIG. 1 is a view of the smallest “Tree” on the suction cup. This would be for small male pets. The “Tree” can be placed in the best position for the pet on the bottom of the litter box by putting pressure on the suction cup. If the “Tree” needs to be cleaned, it can be removed, washed and replaced. If there are female pets, the box will be of great use without the “Tree”.

FIG. 3 is a view of the smallest “Fire Hydrant” on the suction cup. This would be for small male pets. The “Fire Hydrant” can be placed in the best position for the pet on the bottom of the litter box by putting pressure on the suction cup. If the “Fire Hydrant” needs to be cleaned, it can be removed, washed and replaced. If there are female pets, the box will be of great use without the “Fire Hydrant”.

FIG. 6 is a view of the “Litter Box”. This has high sides for male dogs use to lift their leg on as an alternative. Also, to prevent urine from escaping the litter box when hitting the “Tree” or “Fire Hydrant” and when pets try to cover their relief, whether it be urine or feces.

FIG. 7 shows a three-dimensional view of all the parts included in this box, depicted in FIG. 1, FIG. 3 and FIG. 6.

### DETAILED DESCRIPTION

The universal potty system depicted here can be used to provide an indoor potty training for both male and female pets.

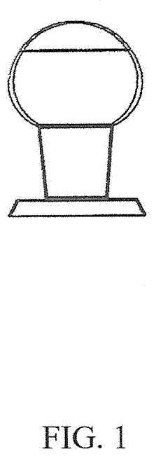

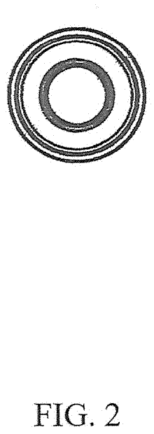

Starting off with FIG. 1, the “Tree” is blow molded polypropylene. It is broken down into 3 parts. The suction cup, the trunk and the umbrella. The suction cup is made of Silicone and painted brown. The trunk is cone shaped and painted brown.

The umbrella is spherical and painted green.

In FIG. 2, you are looking down on the “Tree” and seeing the top of the spherical umbrella, painted green.

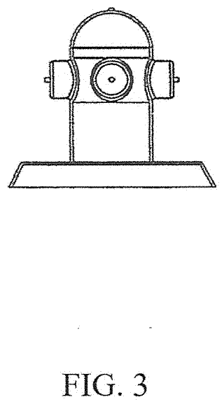

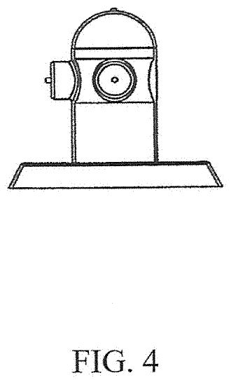

In FIG. 3, the “Fire Hydrant” is blow molded polypropylene. It is broken down into 3 parts. The suction cup, the Hydrant and the Water Valves. The suction cup is made of Silicone and painted red. The Hydrant is shaped like a fire hydrant and painted red. There can be three Water Valves which would be painted red.

FIG. 4 is a continuation of FIG. 3. It shows a side view of the “Fire Hydrant” depicting only one Water Valve extended out and a direct view upon the other Water Valve.

FIG. 5 is also a continuation of FIG. 3. It is showing the view of the “Fire Hydrant” as if you were looking down upon it.

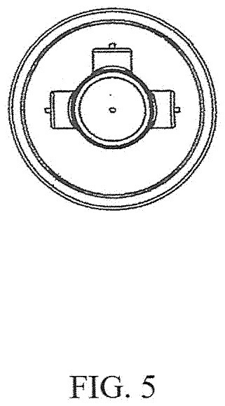

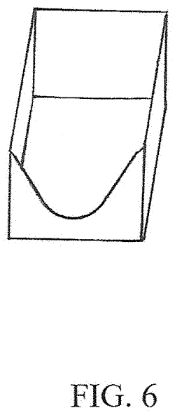

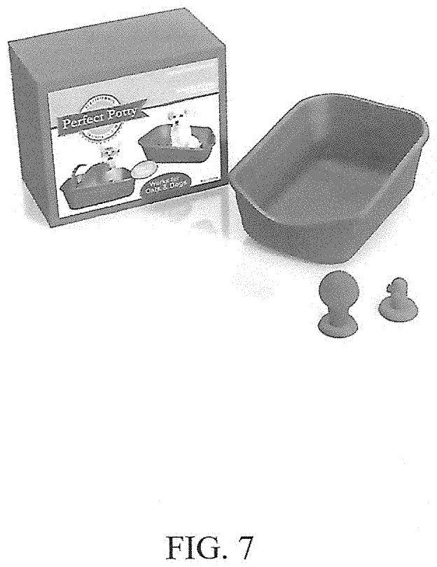

FIG. 6 shows the “Litter Box” with its high walls. One wall having a slight dip for easy access and departure. It is made of plastic.

It is to be understood, that there are different size pets. Therefore, the size of this invention will possibly need to change or be modified at times to meet the sizes required.

1: 1. This is a Universal Litter Box for training both female and male pets how to use indoor litter boxes. However, training male pets to use an indoor litter box can be nearly IMPOSSIBLE! And I figured our family couldn't be the only ones having this problem with male pets. So, I looked in pet stores for something that might help and couldn't find what I thought would work. Which made me come up with my idea. Most male pets like to lift their leg, why not give them something at their height to lift their leg on. Something the owner can place anywhere convenient in the litter box and remove when necessary. Such as, if the pet is female or there is a need to clean.

2: (canceled)

3: (canceled)

4: A “Litter Box” of claim 1, any color made with high sides to fit any dog or cat.

7: A “Litter Box” of claim 4, in different sizes. Depending on the size of the pets. The “Litter Box” can be bigger.
